(19) United States
(12) Patent Application Publication
(10) Pub. No.: US 2013/0113826 A1
(43) Pub. Date: May 9, 2013

(54) IMAGE PROCESSING APPARATUS, IMAGE PROCESSING METHOD, AND PROGRAM

(71) Applicant: Reiko MIYAZAKI, Tokyo (JP)

(72) Inventor: Reiko MIYAZAKI, Tokyo (JP)

(73) Assignee: SONY CORPORATION, Tokyo (JP)

(21) Appl. No.: 13/596,275

(22) Filed: Aug. 28, 2012

(30) Foreign Application Priority Data
Nov. 4, 2011 (JP) 2011-242012

(51) Int. Cl. G09G 5/00

(52) U.S. Cl. 345/632

(57) ABSTRACT

Provided is an image processing apparatus including an image processing unit for combining a virtual object with a captured image. The image processing unit determines the virtual object based on a size, in a real space, of an object shown in the captured image.

### BACKGROUND

The present disclosure relates to an image processing apparatus, an image processing method, and a program.

When purchasing clothes, a user sometimes actually tries on clothes in a shop and selects clothes that match the user's body size as clothes to purchase. However, in a case of purchasing clothes on the Internet, for example, the user is not able to actually pick up clothes and select clothes. Moreover, the user may also purchase clothes that match the measurement result of the user's body size. However, in this case, the user has to go through the trouble of measuring the body size.

On the other hand, a technology is known that combines various objects with an image obtained by capturing (hereinafter, also referred to as a “captured image”). Various objects may be combined with a captured image, and, for example, in the case an image of a subject (such as a person or an animal) is captured, an image of a thing that the subject has on (such as clothes or a bag) may be combined with the captured image as the object. Various technologies are disclosed as the technology for combining an object with a captured image.

For example, a technology for combining an image of clothes with an image of a person is disclosed (for example, see JP 2005-136841A). By looking at a combined image obtained by combining an image of clothes with an image of a person, a user can select clothes knowing how the user would look when the user wears the clothes, even if the user does not actually try on the clothes in a shop.

### SUMMARY

However, a technology for combining an image of clothes that match a user's body size with an image of a person, for example, is not disclosed. Thus, there is a possibility that an image of clothes where a user's body size is not taken into account is combined with an image of a person. Therefore, it is desirable that a technology for determining a virtual object to be combined with a captured image based on the size, in a real space, of an object shown in the captured image is realized.

According to the present disclosure, there is provided an image processing apparatus including an image processing unit for combining a virtual object with a captured image. The image processing unit determines the virtual object based on a size, in a real space, of an object shown in the captured image.

According to the present disclosure, there is provided an image processing method including determining a virtual object to be combined with a captured image, based on a size, in a real space, of an object shown in the captured image.

According to the present disclosure, there is provided a program for causing a computer to function as an image processing apparatus including an image processing unit for combining a virtual object with a captured image. The image processing unit determines the virtual object based on a size, in a real space, of an object shown in the captured image.

As described above, according to the present disclosure, a virtual object to be combined with a captured image can be determined based on the size, in the real space, of an object shown in the captured image.

### BRIEF DESCRIPTION OF THE DRAWINGS

FIG. 1 is a diagram for explaining an overview of an image processing system according to an embodiment of the present disclosure;

FIG. 2 is a block diagram showing an example configuration of an image processing apparatus;

FIG. 3 is a diagram for explaining skeletal structure information and depth information;

FIG. 4 is a diagram for explaining an example of a function of each of a size measuring unit and an image processing unit of the image processing apparatus;

FIG. 5 is a diagram showing examples of a combined image generated by the image processing apparatus; and

FIG. 6 is a flow chart showing an example of a flow of operation of the image processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Also, in this specification and the drawings, a plurality of structural elements having substantially the same functional configuration may be distinguished from each other by each having a different letter added to the same reference numeral. However, if it is not particularly necessary to distinguish each of a plurality of structural elements having substantially the same functional configuration, only the same reference numeral is assigned.

An explanation will be given in “DETAILED DESCRIPTION OF THE EMBODIMENT(S)” according to the following order.

1. Overview of Image Processing System

2. Function of Image Processing Apparatus

3. Operation of Image Processing Apparatus

4. Summary

<1. Overview of Image Processing System>

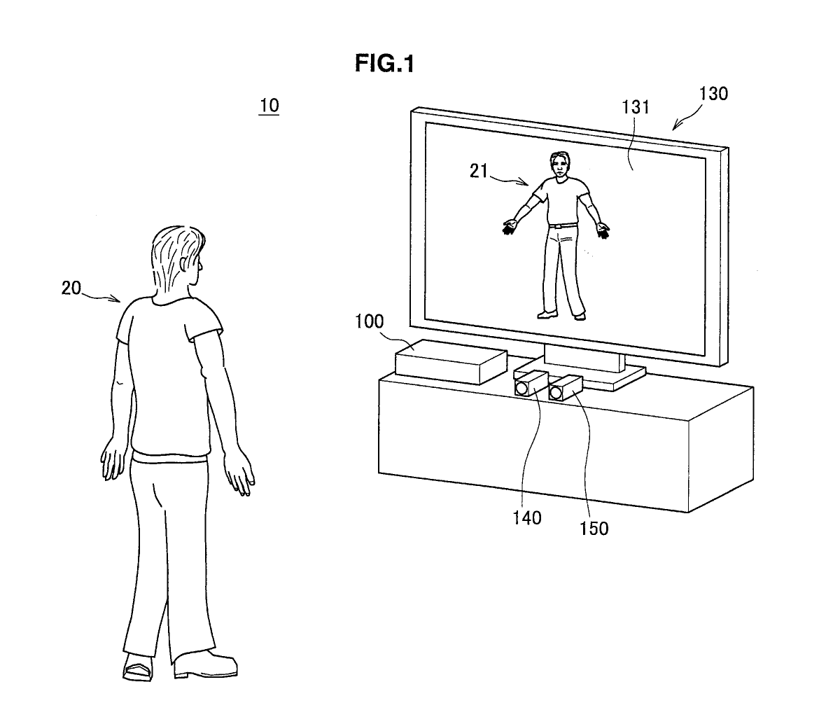

In the following, first, an overview of an image processing system according to an embodiment of the present disclosure will be described with reference to FIG. 1.

FIG. 1 is a diagram for explaining an overview of an image processing system according to the embodiment of the present disclosure. As shown in FIG. 1, an image processing system 10 according to the embodiment of the present disclosure includes an image processing apparatus 100, a display unit 130, an image capturing unit 140, and a sensor 150. The place that the image processing system 10 is to be installed is not particularly limited. For example, the image processing system 10 may be installed at the home of a subject 20.

Also, in the example shown in FIG. 1, a plurality of blocks configuring the image processing system 10 (for example, the image processing apparatus 100, the display unit 130, the image capturing unit 140, and the sensor 150) are separately configured, but a combination of some of the plurality of blocks configuring the image processing apparatus 10 may be integrated into one. For example, the plurality of blocks configuring the image processing system 10 may be embedded in a smartphone, a PDA (Personal Digital Assistant), a mobile phone, a portable music reproduction device, a portable video processing device, or a portable game device.

The image capturing unit 140 captures an image of an object existing in the real space. An object existing in the real space is not particularly limited, but may be a living thing such as a person or an animal, or a thing other than the living thing, such as a garage or a TV table, for example. In the example shown in FIG. 1, a subject 20 (for example, a person) is captured by the image capturing unit 140 as the object existing in the real space. An image captured by the image capturing unit 140 (hereinafter, also referred to as a “captured image”) may be displayed by the display unit 130. The captured image to be displayed by the display unit 130 may be an RGB image. In the example shown in FIG. 1, a captured image 131 showing a subject 21 is displayed by the display unit 130.

The sensor 150 has a function of detecting a parameter in the real space. For example, in the case the sensor 150 is configured from an infrared sensor, the sensor 150 can detect infrared radiation in the real space, and supply, as detection data, an electric signal according to the amount of infrared radiation to the image processing apparatus 100. The image processing apparatus 100 can recognize the object existing in the real space based on the detection data, for example. The type of the sensor 150 is not limited to the infrared sensor. Additionally, in the example shown in FIG. 1, the detection data is supplied from the sensor 150 to the image processing apparatus 100, but the detection data to be supplied to the image processing apparatus 100 may also be an image captured by the image capturing unit 140.

A captured image is processed by the image processing apparatus 100. For example, the image processing apparatus 100 can process the captured image by combining a virtual object with the captured image according to the recognition result of an object existing in the real space. The display unit 130 can also display a captured image which has been processed by the image processing apparatus 100. For example, in the case the position of the subject 21 is recognized by the image processing apparatus 100, a captured image in which a virtual object (such as an image of clothes) is combined at the position of the subject 21 may be displayed by the display unit 130. Combining of a virtual object may be performed by superimposing an image that is registered in advance and separately from the captured image on the captured image, or by modifying the captured image (for example, by superimposing an image captured from the captured image on the captured image).

By looking at the captured image processed in this manner, the subject 20 can select clothes knowing how he/she would look when he/she has worn the clothes without actually trying the clothes on. However, a technology of combining an image of clothes that match the size of the subject 20 with the subject 21 is not disclosed. Thus, an image of clothes not taking into account the size of the subject 20 is possibly combined with the subject 21. Accordingly, realization of a technology is desired that determines a virtual object to be combined with a captured image based on the size, in the real space, of the object shown in the captured image.

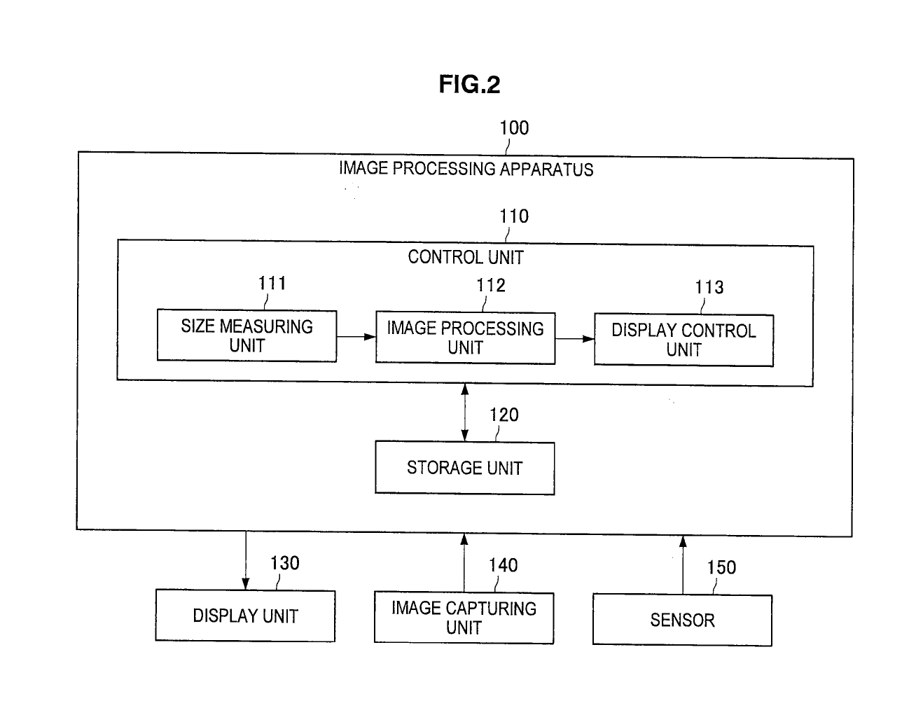

Accordingly, the embodiment of the present disclosure has been attained with the above circumstance in mind. According to the embodiment of the present disclosure, a virtual object to be combined with a captured image can be determined based on the size, in the real space, of the object shown in the captured image. In the following, a function of the image processing apparatus 100 according to the embodiment of the present disclosure will be described with reference to FIGS. 2 to 5.

<2. Function of Image Processing Apparatus>

FIG. 2 is a block diagram showing an example configuration of the image processing apparatus 100. Referring to FIG. 2, the image processing apparatus 100 includes a control unit 110 and a storage unit 120. The control unit 110 includes a size measuring unit 111, an image processing unit 112, and a display control unit 113. The display unit 130, the image capturing unit 140, and the sensor 150 are connected to the image processing apparatus 100.

(Control Unit)

The control unit 110 corresponds to a processor such as a CPU (Central Processing Unit) or a DSP (Digital Signal Processor). The control unit 110 causes various functions of the control unit 110 described later to operate, by executing a program stored in the storage unit 120 or other storage media. Additionally, blocks configuring the control unit 110 do not all have to be embedded in the same device, and one or some of them may be embedded in another device (such as a server).

(Storage Unit)

The storage unit 120 stores program and data for processing of the image processing apparatus 100 using a storage medium such as a semiconductor memory or a hard disk. For example, the storage unit 120 stores a program for causing a computer to function as the control unit 110. Also, for example, the storage unit 120 stores data to be used by the control unit 110. For example, the storage unit 120 can store feature quantity dictionary to be used for object recognition and virtual objects to be displayed.

(Display Unit)

The display unit 130 is a display module that is configured from an LCD (Liquid Crystal Display), an OLED (Organic Light-Emitting Diode), a CRT (Cathode Ray Tube), or the like. In the embodiment of the present disclosure, the display unit 130 is assumed to be configured separately from the image processing apparatus 100, but the display unit 130 may be a part of the image processing apparatus 100.

(Image Capturing Unit)

The image capturing unit 140 generates a captured image by capturing the real space using an image sensor such as a CCD (Charge Coupled Device) or a CMOS (Complementary Metal Oxide Semiconductor). In the embodiment of the present disclosure, the image capturing unit 140 is assumed to be configured separately from the image processing apparatus 100, but the image capturing unit 140 may be a part of the image processing apparatus 100.

(Sensor)

The sensor 150 has a function of detecting a parameter in the real space. For example, in the case the sensor 150 is configured from an infrared sensor, the sensor 150 can detect infrared radiation in the real space, and supply, as detection data, an electric signal according to the amount of infrared radiation to the image processing apparatus 100. The type of the sensor 150 is not limited to the infrared sensor. Additionally, in the case an image captured by the image capturing unit 140 is to be supplied to the image processing apparatus 100 as the detection data, the sensor 150 does not have to exist.

(Size Measuring Unit)

The size measuring unit 111 measures the size, in the real space, of an object shown in a captured image, based on detection data. The method of measuring the size, in the real space, of an object shown in a captured image is not particularly limited. For example, the size measuring unit 111 can first recognize an area where an object exists in a captured image (hereinafter, referred to also as an “object existing region”), and also, acquire the distance between the sensor 150 and the object. The size of the object existing region may be the size of any part of the object existing region. Then, the size measuring unit 111 can determine the size, in the real space, of the object shown in the captured image, based on the size of the object existing region and the distance.

Various methods can be conceived of as the method of recognizing the object existing region. For example, in the case a captured image is supplied to the image processing apparatus 100 as the detection data, the size measuring unit 111 can recognize the object existing region based on a difference value between a captured image before the object is reflected and a captured image in which the object is shown. More particularly, the size measuring unit 111 may recognize an area where the difference value between the captured image before the object is reflected and the captured image in which the object is shown exceeds a threshold value as the object existing region.

Furthermore, in the case a parameter detected by the sensor 150 is supplied to the image processing apparatus 100 as the detection data, the size measuring unit 111 may recognize the object existing region based on the detection data. More particularly, the size measuring unit 111 may recognize an area where the detected amount of infrared radiation exceeds a threshold value as the object existing region.

Various methods can be conceived of also as the method of acquiring the distance between the sensor 150 and an object. For example, the distance between the sensor 150 and an object can be set in advance. That is, a limitation may be imposed such that an object is placed at a position separate from the sensor 150 by a distance set in advance. If such a limitation is imposed, the size measuring unit 111 can treat the distance between the sensor 150 and an object as being a fixed value (for example, 2 m).

Furthermore, the size measuring unit 111 may recognize the distance between the image capturing unit 140 and an object from a captured image. For example, the size measuring unit 111 may recognize the distance between the image capturing unit 140 and an object based on a length of a portion which does not vary greatly from one object to another. For example, as shown in FIG. 1, in the case of capturing the subject 20, the distance between the image capturing unit 140 and the subject 20 may be recognized based on a length of a portion which does not vary greatly from one person to another (such as the distance between the left and right eyes). The size measuring unit 111 matches the feature quantity determined from the captured image against the feature quantity of an object, and can thereby recognize the object included in the captured image. Using such a recognition method, the size measuring unit 111 can recognize the left and right eyes included in the captured image.

More specifically, the size measuring unit 111 determines a feature quantity in a captured image according to a feature quantity determination method such as SIFT method or Random Ferns method, and matches the determined feature quantity against the feature quantity of an object. Then, the size measuring unit 111 recognizes information which is for identifying the object associated with a feature quantity that best matches the feature quantity in the captured image, and the position and the attitude of the object in the captured image.

Here, a feature quantity dictionary in which feature quantity data of objects and information for identifying objects are associated is used by the size measuring unit 111. This feature quantity dictionary may be stored in the storage unit 120, or may be received from a server. The feature quantity data of an object may be a collection of feature quantities determined from images for learning of an object according to SIFT method or Random Ferns method, for example.

Furthermore, if, for example, the distance can be calculated based on the parameter detected by the sensor 150, the size measuring unit 111 can also calculate the distance between the sensor 150 and an object based on the detection data. More particularly, when light such as an infrared ray is irradiated toward an object from an irradiation device not shown, the size measuring unit 111 can calculate the distance between the sensor 150 and an object by analyzing the light detected by the sensor 150.

For example, the size measuring unit 111 can calculate the distance between the sensor 150 and an object based on the phase delay of light detected by the sensor 150. This method is referred to as TOF (Time of Flight) method. Or, in the case light irradiated by an irradiation device not shown is formed by a known pattern, the size measuring unit 111 may calculate the distance between the sensor 150 and an object by analyzing the degree of distortion of the pattern forming the light detected by the sensor 150.

The size, in the real space, of an object shown in a captured image can be measured based on detection data by a method as described above. The size measuring unit 111 may also be integrated not in the image processing apparatus 100, but in the sensor 150.

In the foregoing, it is assumed that the size measuring unit 111 measures the size, in the real space, of an object, but it can also measure the size, in the real space, of each part of an object. For example, as in the case of recognizing an object, the size measuring unit 111 can recognize a part of an object included in a captured image by matching a feature quantity determined from the captured image against a feature quantity of each part of the object. The size measuring unit 111 can measure the size, in the real space, of an object for each part based on the recognition result and the distance between the sensor 150 and the object.

Or, the size measuring unit 111 can recognize a part of an object by matching a feature quantity determined from the detection data supplied from the sensor 150, instead of the captured image, against the feature quantity of each part of the object. The size measuring unit 111 can measure the size, in the real space, of an object for each part based on the recognition result and the distance between the sensor 150 and the object.

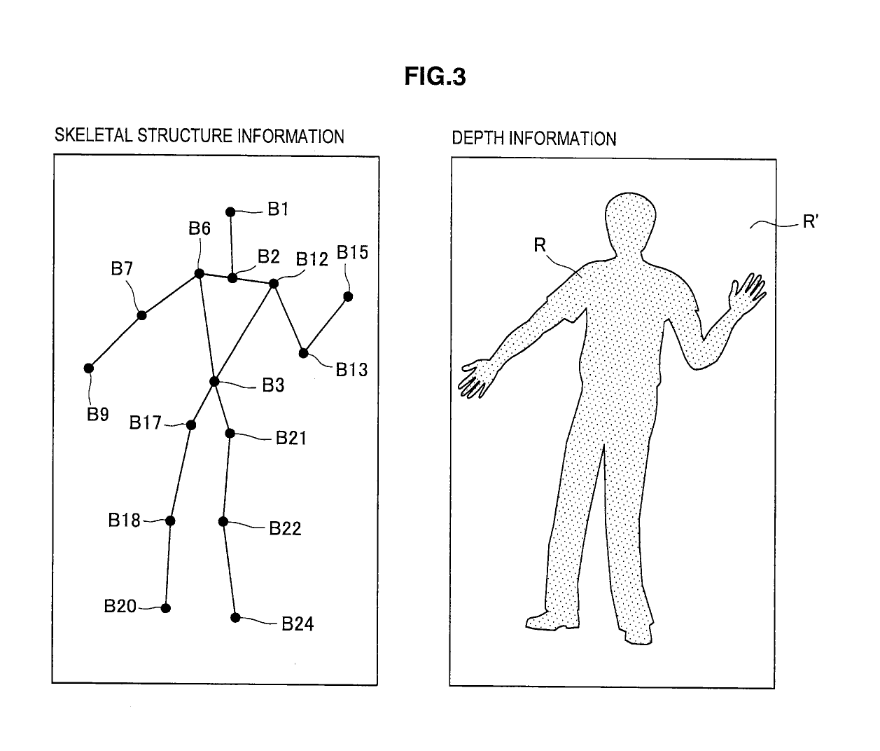

A known art (for example, Kinect (registered trademark) developed by Microsoft Corporation (registered trademark)) can be used to measure the size, in the real space, of an object for each part. By using such a known art, the size measuring unit 111 can acquire skeletal structure information as an example of coordinates showing the position of each of one or more parts forming the subject 20. The size measuring unit 111 can measure the size of each part forming the subject 20 based on the skeletal structure information. Or, the size measuring unit 111 can measure the size of each part forming the subject 20 based on the skeletal structure information and depth information. First, the skeletal structure information and the depth information will be described with reference to FIG. 3.

FIG. 3 is a diagram for explaining the skeletal structure information and the depth information. The size measuring unit 111 can acquire skeletal structure information as shown in FIG. 3 by using the known art described above. In the example shown in FIG. 3, the skeletal structure information is shown as coordinates B1 to B3, B6, B7, B9, B12, B13, B15, B17, B18, B20 to B22, and B24 showing 15 parts forming the subject 20, but the number of parts included in the skeletal structure information is not particularly limited.

Additionally, the coordinates B1 represent the coordinates of “Head”, the coordinates B2 represent the coordinates of “Neck”, the coordinates B3 represent the coordinates of “Torso”, the coordinates B6 represent the coordinates of “Left Shoulder”, and the coordinates B7 represent the coordinates of “Left Elbow”. Also, the coordinates B9 represent the coordinates of “Left Hand”, the coordinates B12 represent the coordinates of “Right Shoulder”, the coordinates B13 represent the coordinates of “Right Elbow”, and the coordinates B15 represent the coordinates of “Right Hand”.

The coordinates B17 represent the coordinates of “Left Hip”, the coordinates B18 represent the coordinates of “Left Knee”, the coordinates B20 represent the coordinates of “Left Foot”, and the coordinates B21 represent the coordinates of “Right Hip”. The coordinates B22 represent the coordinates of “Right Knee”, and the coordinates B24 represent the coordinates of “Right Foot”.

Furthermore, the size measuring unit 111 can acquire depth information as shown in FIG. 3 by using the known art described above. The depth information is information indicating the distance from the sensor 150, and, in FIG. 3, an object existing region R where the depth is below a threshold value (a region where the distance from the sensor 150 is less than the threshold value) and other region R′ are shown as examples of the depth information for the sake of simplicity.

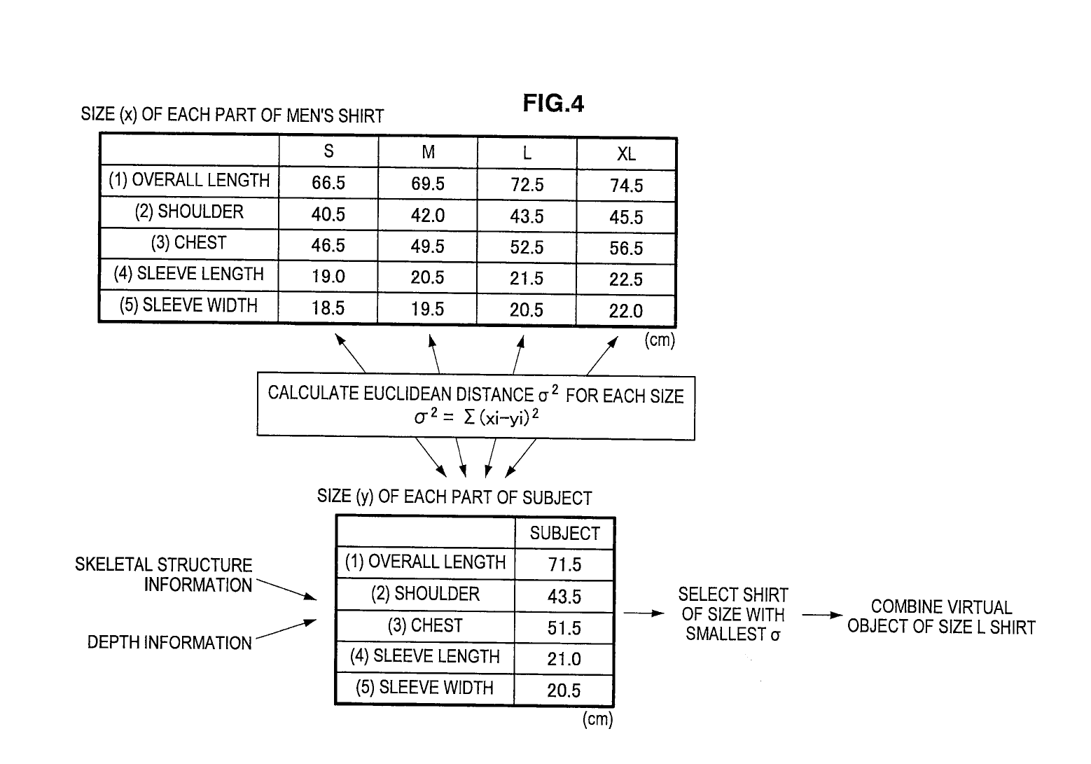

The size of a part forming the subject 20 may be measured by the size measuring unit 111 based on the skeletal structure information acquired in the above manner. Or, the size of a part forming the subject 20 may be measured by the size measuring unit 111 based on the skeletal structure information and the depth information acquired in the above manner. In the following, a method of measuring the size of a part forming the subject 20 will be described with reference to FIG. 4.

FIG. 4 is a diagram for explaining an example of a function of each of the size measuring unit 111 and the image processing unit 112 of the image processing apparatus 100. The size measuring unit 111 can, for example, measure “overall length” and “sleeve length” based on the skeletal structure information. More particularly, the size measuring unit 111 can measure “overall length” by using the coordinates B1. Also, the size measuring unit 111 can measure “sleeve length” by using a result obtained by adding a difference value between the coordinates B6 and the coordinates B7 and a difference value between the coordinates B7 and the coordinates B9. Or, the size measuring unit 111 can measure “sleeve length” by using a result obtained by adding a difference value between the coordinates B12 and the coordinates B13 and a difference value between the coordinates B13 and the coordinates B15.

Also, the size measuring unit 111 can, for example, measure “shoulder”, “chest”, and “sleeve width” based on the skeletal structure information and the depth information. More particularly, the size measuring unit 111 can measure “shoulder” by using a result obtained by adding, to a difference value between the coordinates B6 and the coordinates B12, the thickness of each part shown by the coordinates B6 and the coordinates B12 in the object existing region R. Also, the size measuring unit 111 can measure “chest” by using the thickness of a part positioned between the coordinates B3 and the coordinates B6 or the coordinates B12 in the object exiting region R. Furthermore, the size measuring unit 111 can measure “sleeve width” by using the thickness of a part positioned at the coordinates B6 or the coordinates B12 in the object existing region R.

In FIG. 4, an example of a size (y) of each part of the subject 20 measured by the size measuring unit 111 is shown. In this example, the size of each part of the subject 20 is measured to be as follows: “(1) overall length=71.5 cm”, “(2) shoulder=43.5 cm”, “(3) chest=51.5 cm”, “(4) sleeve length=21.0 cm, and “(5) sleeve width=20.5 cm”. Here, five parts are measured by the size measuring unit 111 as the sizes of the subject 20, but the number of parts whose size is to be measured is not particularly limited.

(Image Processing Unit)

Next, a method of processing a captured image by the image processing unit 112 will be described with reference to FIG. 4. The image processing unit 112 processes a captured image based on the size, in the real space, of an object shown in the captured image. The size, in the real space, of an object shown in the captured image may be measured by the size measuring unit 111 as described above. No particular limitation is imposed as to how the image processing unit 112 processes the captured image. For example, as described above, the image processing unit 112 can process the captured image by combining a virtual object with the captured image based on the size, in the real space, of an object shown in the captured image. As described above, combining of a virtual object may be performed by superimposing an image that is registered in advance and separately from the captured image on the captured image, or by modifying the captured image (for example, by superimposing an image captured from the captured image on the captured image).

For example, the image processing unit 112 can combine, with the captured image, a virtual object that is according to a real object (hereinafter, referred to also as a “selected object”) selected based on a result of matching between the size, in the real space, of an object and the size of each of one or more real objects that are registered in advance. Although not particularly limited, a real object may be a living thing such as a person or an animal, or a thing other than the living thing, such as a vehicle or a piece of furniture. The size of each of one or more real objects may be registered in the storage unit 120 in advance.

In the case there are corresponding parts with respect to the size, in the real space, of an object and the size of each of one or more real objects, a selected object may be selected based on a matching result for each of respective corresponding parts. More particularly, a selected object may be a real object whose sum of squares of difference values of corresponding parts is the smallest. FIG. 4 shows an example where a size (x) of each part of men's shirts is registered in advance as the size of each part of one or more real objects.

In this example, the overall length (1) of men's shirts is registered to be “(size S) 66.5 cm, (size M) 69.5 cm, (size L) 72.5 cm, (size XL) 74.5 cm”. Also, the shoulder (2) of men's shirts is registered to be “(size S) 40.5 cm, (size M) 42.0 cm, (size L) 43.5 cm, (size XL) 45.5 cm”. Furthermore, the chest (3) of men's shirts is registered to be “(size S) 46.5 cm, (size M) 49.5 cm, (size L) 52.5 cm, (size XL) 56.5 cm”.

Also, the sleeve length (4) of men's shirts is registered to be “(size S) 19.0 cm, (size M) 20.5 cm, (size L) 21.5 cm, (size XL) 22.5 cm”. Furthermore, the sleeve width (5) of men's shirts is registered to be “(size S) 18.5 cm, (size M) 19.5 cm, (size L) 20.5 cm, (size XL) 22.0 cm”. The image processing unit 112 can calculate a sum σ² of squares of difference values of corresponding parts based on the following equation (1), for example.

σ²=Σ(xi−yi)² (1)

For example, if σ² is calculated with respect to size S, the following is obtained: σ_{S}²=(66.5 cm−71.5 cm)²+(40.5 cm−43.5 cm)²+(46.5 cm−51.5 cm)²+(19.0 cm−21.0 cm)²+(18.5 cm−20.5 cm)²=67 cm². Likewise, if σ² is calculated with respect to each of size M, size L, and size XL, the following is obtained: σ_{M}²=11.5 cm², σ_{L}²=2.25 cm², σ_{XL}²=42.5 cm².

Accordingly, in the example shown in FIG. 4, the image processing unit 112 can select a size L shirt as the shirt of a size with the smallest σ². Additionally, here, it is assumed that the image processing unit 112 selects a real object whose sum of squares of difference values of corresponding parts is the smallest, but it is also possible to select a real object whose sum of difference values of corresponding parts is the smallest.

Or, the image processing unit 112 may preferentially select a real object having a small difference value with respect to a specific part. If such selection is performed, it is possible to take into account conditions allowing, for example, large difference values with respect to “overall length”, “sleeve length” and the like, but not with respect to “shoulder”, “chest”, “sleeve width” and the like. That is, the specific parts may be “shoulder”, “chest”, “sleeve width” and the like. The image processing unit 112 can process a captured image by combining a virtual object according to a selected object with the captured image.

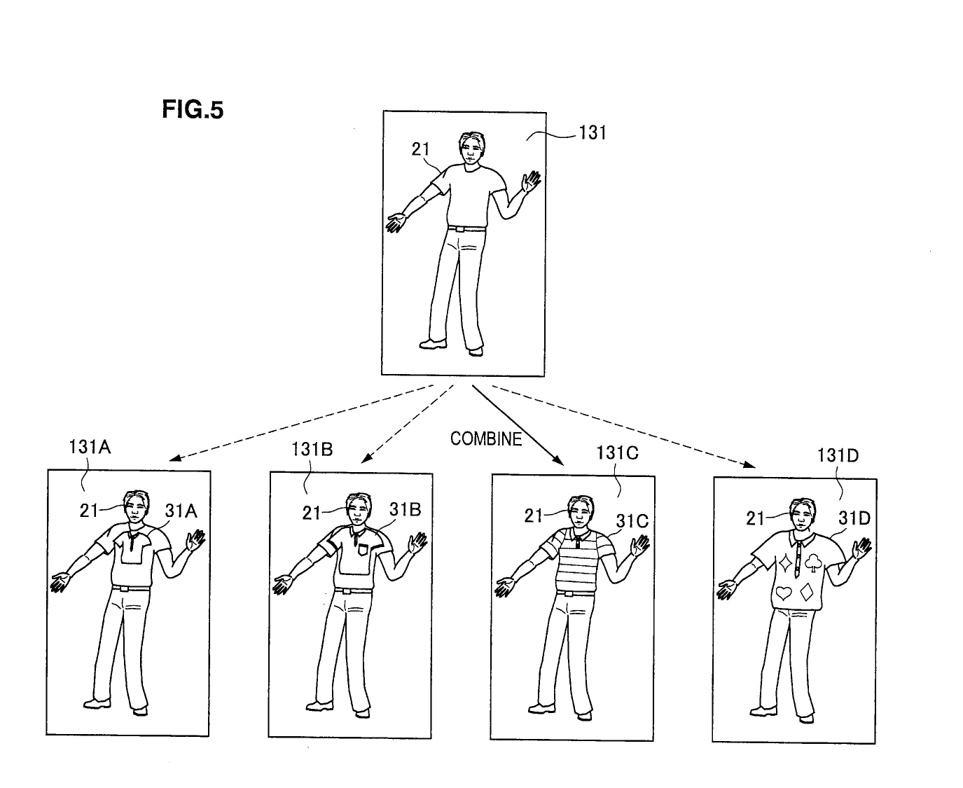

The virtual object may be prepared for each real object. In this case, a virtual object according to a selected object may be a virtual object that is associated with the selected object, for example. Furthermore, the virtual object does not have to be prepared for each real object. In this case, a virtual object according to a selected object may be a virtual object which has been adjusted in accordance with the size of the selected object, for example. The size of a virtual object to be combined with a captured image may be changed according to the distance between the sensor 150 and the object. In the following, an example of a captured image with which a virtual object has been combined by the image processing unit 112 will be described with reference to FIG. 5.

FIG. 5 is a diagram showing examples of a combined image generated by the image processing apparatus 100. As shown in FIG. 5, the image processing unit 112 can obtain a captured image 131C by combining, with the subject 21, a virtual object 31C according to a size L shirt selected based on the size, in the real space, of the subject 20. Referring to FIG. 5, it can be seen that the combined virtual object 31C matches the size of the subject 21.

On the other hand, referring to a captured image 131A which is obtained when a virtual object 31A according to a size S shirt is combined with the subject 21, it can be seen that the virtual object 31A does not match the size of the subject 21. Likewise, referring to a captured image 131B which is obtained when a virtual object 31B according to a size M shirt is combined with the subject 21, it can be seen that the virtual object 31B does not match the size of the subject 21. Referring further to a captured image 131D which is obtained when a virtual object 31D according to a size XL shirt is combined with the subject 21, it can be seen that the virtual object 31D does not match the size of the subject 21.

(Display Control Unit)

The display unit 130 is controlled by the display control unit 113 such that a captured image which has been processed by the image processing unit 112 is displayed by the display unit 130. In the example shown in FIG. 5, the display unit 130 is controlled by the display control unit 113 such that the captured image 131C is displayed by the display unit 130.

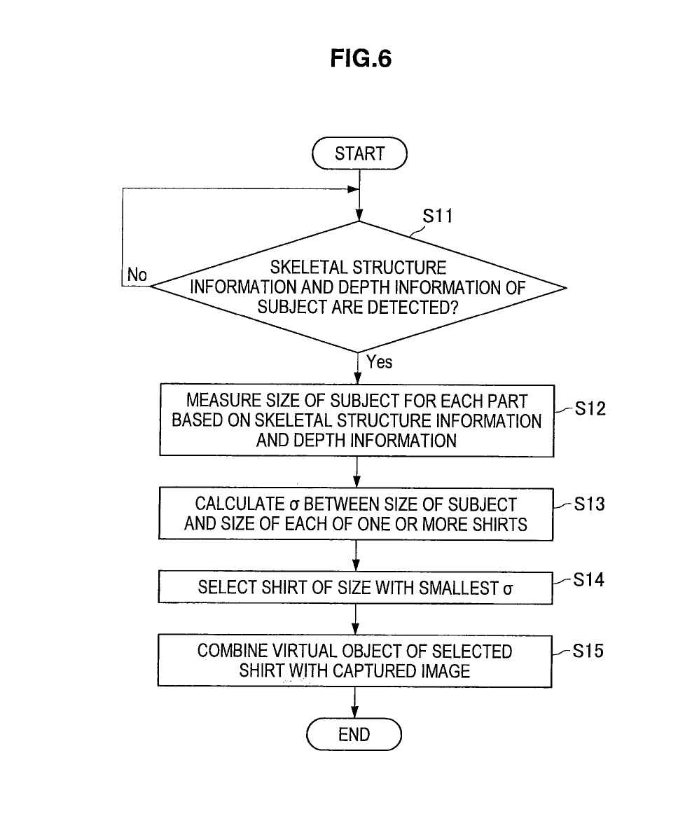

Heretofore, the functions of the image processing apparatus 100 according to the embodiment of the present disclosure have been described with reference to FIGS. 2 to 5. In the following, an example of a flow of operation of the image processing apparatus 100 according to the embodiment of the present disclosure will be described with reference to FIG. 6.

<3. Operation of Image Processing Apparatus>

FIG. 6 is a flow chart showing an example of a flow of operation of the image processing apparatus 100 according to the embodiment of the present disclosure. Additionally, the operation of the image processing apparatus 100 described with reference to FIG. 6 is particularly the operation of the image processing apparatus 100 for a case where the size of a subject is measured for each part based on the skeletal structure information and the depth information of the subject 20. Also, the operation of the image processing apparatus 100 described with reference to FIG. 6 is an operation for a case where the real object is a shirt.

As shown in FIG. 6, first, the size measuring unit 111 detects the skeletal structure information and the depth information of the subject 20 (step S11). Then, the size measuring unit 111 measures the size, in the real space, of the subject 20 for each part based on the skeletal structure information and the depth information (step S12). The image processing unit 112 calculates a Euclidean distance σ between the size, in the real space, of the subject 20 measured by the size measuring unit 111 and the size of each of one or more shirts (step S13).

The image processing unit 112 selects a shirt of a size with the smallest Euclidean distance σ (step S14), and combines a virtual object of the selected shirt with a captured image (step S15). The display unit 130 may be controlled by the display control unit 113 such that the captured image with which the virtual object has been combined is displayed by the display unit 130.

Heretofore, an example of a flow of the operation of the image processing apparatus 100 has been described with reference to FIG. 6.

<4. Summary>

As described above, according to the embodiment of the present disclosure, an image processing apparatus is provided which includes an image processing unit for combining a virtual object with a captured image, where the image processing unit determines the virtual object based on the size, in the real space, of an object shown in the captured image. According to such an image processing apparatus, a virtual object can be determined taking into account the size, in the real space, of an object shown in a captured image. For example, by registering the sizes of clothes that can be provided to a user in advance, clothes of an appropriate size can be proposed to the user based on the size of the clothes and the size, in the real space, of the user.

It should be understood by those skilled in the art that various modifications, combinations, sub-combinations and alterations may occur depending on design requirements and other factors insofar as they are within the scope of the appended claims or the equivalents thereof.

For example, the image processing apparatus 100 including the image processing unit 112 may be provided in a server or in a terminal capable of communication with a server. Also, an example has been mainly described above where the function of measuring the size of an object based on a captured image is provided in the image processing apparatus 100, but such a function may be provided in a device other than the image processing apparatus 100. For example, such as function may be provided in the sensor 150. For example, in a case the image processing apparatus 100 transmitted a captured image to another device, the other device may measure the size of an object based on the captured image, instead of the image processing apparatus 100.

Furthermore, for example, an example has been mainly described above where the display control unit 113 is provided in the image processing apparatus 100, but the display control unit 113 may be provided in a device other than the image processing apparatus 100. For example, the image processing unit 112 may be provided in a server, and the display control unit 113 may be provided in a terminal. For example, in a case a captured image processed by a server is transmitted to a terminal, the terminal may control the display unit 130 such that the captured image is displayed by the display unit 130. In this manner, the technology of the present disclosure can be applied also to cloud computing.

Moreover, for example, an example has been mainly described above where an image of clothes selected based on the size, in the real space, of a user is combined with a captured image by the image processing unit 112, but the object whose size is to be measured is not particularly limited, nor is the virtual object to be combined with a captured image particularly limited. For example, the image processing unit 112 may combine, with a captured image, a virtual object according to a selected object which is a car selected based on a result of matching between the size, in the real space, of a garage and the size of each of one or more cars that are registered in advance. It accordingly becomes possible to propose to a user a car according to the size, in the real space, of the garage.

Further, for example, the image processing unit 112 may combine, with a captured image, a virtual object according to a selected object which is a TV selected based on a result of matching between the size, in the real space, of a TV table and the size of each of one or more TVs that are registered in advance. It accordingly becomes possible to propose to a user a TV according to the size, in the real space, of the TV table.

Furthermore, for example, the image processing unit 112 may combine, with a captured image, a virtual object according to a selected object which is a case selected based on a result of matching between the size, in the real space, of contents and the size of each of one or more cases that are registered in advance. It accordingly becomes possible to propose to a user a case according to the size, in the real space, of contents. The case may be a bag or a suitcase.

Also, for example, the image processing unit 112 may combine, with a captured image, a virtual object according to a selected object which is a placard selected based on a result of matching between the size, in the real space, of a wall shown in the captured image and the size of each of one or more placards that are registered in advance. It accordingly becomes possible to propose to a user a placard to be hung on the wall. The placard may be a picture or a poster.

Furthermore, for example, the image processing unit 112 may combine, with a captured image, a virtual object according to a selected object which is an object selected based on a result of matching between the size, in the real space, of the space between a plurality of objects shown in the captured image and the size of each of one or more objects that are registered in advance. It accordingly becomes possible to propose to a user an object that would fit in the space between a plurality of objects. The object may be a piece of furniture or an appliance such as a TV or a speaker.

Moreover, for example, an example is mainly described above where a virtual object is combined with a captured image by superimposing, on the captured image, an image that is registered in advance and separately from the captured image, based on the size, in the real space, of an object shown in the captured image, but the image processing unit 112 may combine a virtual object with a captured image by modifying the captured image according to the size, in the real space, of an object. The image processing unit 112 may modify the captured image by changing the arrangement of objects according to the size, in the real space, of an object. For example, the image processing unit 112 may modify the captured image by changing, based on the size, in the real space, of a piece of furniture shown in the captured image, the arrangement of other pieces of furniture such that the piece of furniture fits between the other pieces of furniture in the captured image. Changing of the arrangement of the other pieces of furniture in the captured image may be performed by superimposing, on the captured image, the images of the other pieces of furniture captured from the captured image, for example.

Furthermore, for example, the image processing unit 112 may modify a captured image by changing, based on the size, in the real space, of a piece of baggage shown in the captured image, the arrangement of other pieces of baggage such that the piece of baggage fits between the other pieces of baggage in the captured image. Changing of the arrangement of the other pieces of baggage in the captured image may be performed by superimposing, on the captured image, the images of the other pieces of baggage captured from the captured image, for example. These pieces of baggage may be on the truck bed or the like. If the technology of the present disclosure is applied in such a case, the efficiency of the work of loading baggage on a truck can be increased.

Moreover, the steps of the operation of the image processing apparatus 100 according to the present specification do not necessarily have to be processed chronologically according to the order described as the flow chart. For example, the steps of the operation of the image processing apparatus 100 can also be processed in an order different from that described as the flow chart or may be processed in parallel.

Furthermore, a computer program for causing hardware, such as a CPU, a ROM, and a RAM, embedded in the image processing apparatus 100 to realize an equivalent function as each element of the image processing apparatus 100 described above can also be created. Furthermore, a storage medium storing the computer program is also provided.

Additionally, the following configurations are also within the technical scope of the present disclosure.

(1) An image processing apparatus including:

an image processing unit for combining a virtual object with a captured image,

wherein the image processing unit determines the virtual object based on a size, in a real space, of an object shown in the captured image.

(2) The image processing apparatus according to (1), wherein the image processing unit combines, with the captured image, a virtual object according to a selected object which is a real object selected based on a result of matching between the size, in the real space, of the object and a size of each of one or more real objects that are registered in advance.
(3) The image processing apparatus according to (2), wherein, in a case there are corresponding parts with respect to the size, in the real space, of the object and the size of each of the one or more real objects, the selected object is selected based on a matching result for each of respective corresponding parts.
(4) The image processing apparatus according to (3), wherein the selected object is a real object whose sum of squares of difference values of corresponding parts is smallest.
(5) The image processing apparatus according to any one of (2) to (4), wherein the image processing unit combines a virtual object with the captured image by superimposing, on the captured image, the virtual object that is registered in advance and separately from the captured image.
(6) The image processing apparatus according to (1), wherein the image processing unit combines the virtual object with the captured image by modifying the captured image according to the size, in the real space, of the object.
(7) The image processing apparatus according to (6), wherein the image processing unit modifies the captured image by changing arrangement of another object shown in the captured image according to the size, in the real space, of the object.
(8) The image processing apparatus according to (1), further including:

a size measuring unit for measuring the size, in the real space, of the object shown in the captured image.

(9) The image processing apparatus according to (1), further including:

a display control unit for controlling a display unit such that an image with which the virtual object has been combined by the image processing unit is displayed by the display unit.

(10) An image processing method including:

determining a virtual object to be combined with a captured image, based on a size, in a real space, of an object shown in the captured image.

(11) A program for causing a computer to function as an image processing apparatus including:

an image processing unit for combining a virtual object with a captured image,

wherein the image processing unit determines the virtual object based on a size, in a real space, of an object shown in the captured image.

The present disclosure contains subject matter related to that disclosed in Japanese Priority Patent Application JP 2011-242012 filed in the Japan Patent Office on Nov. 4, 2011, the entire content of which is hereby incorporated by reference.

What is claimed is:

1. An image processing apparatus comprising:
an image processing unit for combining a virtual object with a captured image,
wherein the image processing unit determines the virtual object based on a size, in a real space, of an object shown in the captured image.

2. The image processing apparatus according to claim 1, wherein the image processing unit combines, with the captured image, a virtual object according to a selected object which is a real object selected based on a result of matching between the size, in the real space, of the object and a size of each of one or more real objects that are registered in advance.

3. The image processing apparatus according to claim 2, wherein, in a case there are corresponding parts with respect to the size, in the real space, of the object and the size of each of the one or more real objects, the selected object is selected based on a matching result for each of respective corresponding parts.

4. The image processing apparatus according to claim 3, wherein the selected object is a real object whose sum of squares of difference values of corresponding parts is smallest.

5. The image processing apparatus according to claim 2, wherein the image processing unit combines a virtual object with the captured image by superimposing, on the captured image, the virtual object that is registered in advance and separately from the captured image.

6. The image processing apparatus according to claim 1, wherein the image processing unit combines the virtual object with the captured image by modifying the captured image according to the size, in the real space, of the object.

7. The image processing apparatus according to claim 6, wherein the image processing unit modifies the captured image by changing arrangement of another object shown in the captured image according to the size, in the real space, of the object.

8. The image processing apparatus according to claim 1, further comprising:
a size measuring unit for measuring the size, in the real space, of the object shown in the captured image.

9. The image processing apparatus according to claim 1, further comprising:
a display control unit for controlling a display unit such that an image with which the virtual object has been combined by the image processing unit is displayed by the display unit.

10. An image processing method comprising:
determining a virtual object to be combined with a captured image, based on a size, in a real space, of an object shown in the captured image.

11. A program for causing a computer to function as an image processing apparatus including:
an image processing unit for combining a virtual object with a captured image,
wherein the image processing unit determines the virtual object based on a size, in a real space, of an object shown in the captured image.
